(19) United States
(12) Patent Application Publication
(10) Pub. No.: US 2025/0158758 A1
(43) Pub. Date: May 15, 2025

(54) MULTI-CHANNEL SCHEDULING

(71) Applicant: Lenovo (Singapore) Pte. Limited, Singapore (SG)

(72) Inventors: Hossein Bagheri, Urbana, IL (US); Razvan-Andrei Stoica, Essen (DE); Hyejung Jung, Northbrook, IL (US); Vijay Nangia, Woodridge, IL (US); Ravi Kuchibhotla, Chicago, IL (US)

(73) Assignee: Lenovo (Singapore) Pte. Limited, Singapore (SG)

(21) Appl. No.: 18/841,183

(22) PCT Filed: Feb. 22, 2023
(86) PCT No.: PCT/IB2023/051631

§ 371 Date: Aug. 23, 2024

Related U.S. Application Data
(60) Provisional application No. 63/313,200, filed on Feb. 23, 2022.

(51) Int. Cl. H04L 1/1867; H04W 72/1273

(52) U.S. Cl. CPC H04L 1/1896; H04W 72/1273

(57) ABSTRACT

Various aspects of the present disclosure relate to a UE that receives control signaling including downlink control information (DCI) scheduling a set of physical downlink shared channel (PDSCH) transmissions, the DCI including an indication of a table row of a time domain resource allocation (TDRA) table, and the table row corresponding to multiple subsets of the set of PDSCH transmissions. The UE receives the set of PDSCH transmissions. The UE can then transmit a respective hybrid automatic repeat request acknowledgement (HARQ-ACK) corresponding to respective one or more of the multiple subsets of the set of PDSCH transmissions.

### RELATED APPLICATION

This application claims priority to U.S. Provisional Application Ser. No. 63/313,200 filed Feb. 23, 2022 entitled “Multi-Channel Scheduling,” the disclosure of which is incorporated by reference herein in its entirety.

### TECHNICAL FIELD

The present disclosure relates to wireless communications, and more specifically to multi-channel scheduling, such as for extended reality (XR) services.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers, bandwidth parts, resource block sets). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Extended reality (XR) refers to all real and virtual combined environments, as well as human-machine interactions generated by computer technology and wearables. It includes representative forms of augmented reality (AR), mixed reality (MR), and virtual reality (VR), as well as the areas interpolated among them. The levels of virtuality range from partially sensory inputs to fully immersive VR. A key aspect of XR is the extension of human experiences, particularly relating to the senses of existence, as represented by VR, and the acquisition of cognition, as represented by AR.

Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided.

Augmented reality (AR) is when a user is provided with additional information or artificially generated items or content overlaid upon their current environment. Such additional information or content will usually be visual and/or audible and their observation of the current environment may be direct, with no intermediate sensing, processing, and rendering, or indirect, where the perception of the environment is relayed via sensors and may be enhanced or processed. Mixed reality (MR) is an advanced form of AR where some virtual elements are inserted into the physical scene with the intent to provide the illusion that these elements are part of the real scene.

### SUMMARY

The present disclosure relates to methods, apparatuses, and systems that support multi-channel scheduling, such as for physical downlink shared channel (PDSCH) scheduling and physical uplink shared channel (PUSCH) scheduling as related to XR services. The XR services encompass different types of digitally-enhanced realities, including VR, AR, and mixed reality MR, and refers to and includes all real and virtual combined environments, as well as human-machine interactions generated by computer technology and wearables. By utilizing the described techniques, a UE can determine one or two PDSCH groups based on the time domain resource allocation (TDRA) indication in downlink control information (DCI). The UE can determine the PDSCH groups based on a resource indication value (RIV)-like indication of the rows of the TDRA table, and determine priority for the first and the second PDSCH groups based on the DCI. The UE can also determine whether and how to bundle hybrid automatic repeat request acknowledgements (HARQ-ACKs) for the first and the second PDSCH groups, which may be based on higher layer or physical layer indications.

Many types of XR and cloud gaming (CG) use cases are characterized by quasi-periodic traffic, with possible jitter, given the high data rate in a downlink video stream combined with the frequent uplink updates, such as for user pose and control updates, and the uplink video stream. Both the downlink and the uplink data traffic are also characterized by a relatively strict packet delay budget (PDB). The set of anticipated XR and CG services poses a variety or characteristics of the data uplink and downlink video streams, and may change “on-the-fly” while the services are running over new radio (5GNR). The XR data traffic characteristics (e.g., variable packet arrival rates with packets received at 30-120 frames per second with some jitter; packets having variable and large packet size; B and P-frames being dependent on I-frames; and the presence of multiple traffic and data flows such as for pose and video scene in uplink) can enable more efficient XR service delivery, such as in terms of satisfying the XR service requirements for a greater number of UEs, or in terms of UE power saving.

For high subcarrier spacing (SCS) (e.g., 960 KHz) associated with large bandwidth and short slot duration, a single DCI can schedule multiple uplink or downlink transport blocks (TBs) to keep physical downlink control channel (PDCCH) blind decoding and control channel element (CCE) budget feasible while still being able to support PDCCH candidates with large aggregation levels (e.g., with 16 CCEs). Assuming multiple contiguous slots can have highly correlated channels (due to small slot duration, and assuming interference is also highly correlated over those slots) and to save feedback overhead, HARQ-ACK corresponding to each group of the multiple downlink TBs can be bundled, where PDSCH groups and/or PUSCH groups are determined based on a radio resource control (RRC) configured number of bundling groups. Additional information on the running services from higher layers, such as the quality of service (QoS) flow association, frame-level QoS, application data unit (ADU)-based QoS, XR specific QoS, etc., can be utilized and is beneficial to facilitate informed choices of radio parameters. Notably, the XR application awareness by both a UE and gNB would improve the user experience, improve the NR system capacity in supporting XR services, and reduce the UE power consumption.

Aspects of the disclosure are directed to a network device (e.g., a UE, a network entity) can receive a TDRA indication in a DCI scheduling a set of PDSCHs or PUSCHs, where the set of PDSCHs or PUSCHs can be associated with one or two groups. A UE can determine two rows of a TDRA table based on the TDRA indication, and one PDSCH group or PUSCH group can be associated to none, one, or two rows of the two rows of the TDRA table. A UE can generate a HARQ-ACK in response to the PDSCHs, or a PUSCH according to the determined two groups. A UE can determine priority of each group based on a priority indication in the DCI. A UE can also determine whether to bundle the HARQ-ACK for each PDSCH group, and in response to determining to bundle the HARQ-ACK for a PDSCH group, the UE can also determine sub-groups for which the HARQ-ACK is to be bundled (e.g., one HARQ-ACK bit is generated corresponding to each PDSCH sub-group). Further, in some of the described implementations, rather than uplink or downlink transmissions and the corresponding PDSCH or PUSCH grouping into two or more groups scheduled via a DCI, multiple sidelink transmissions can be scheduled and grouped via a grant (SCI or DCI), or a first network node may schedule and group multiple transmissions to or from a second network node (IAB relays).

Some implementations of the method and apparatuses described herein may include wireless communication at a device (e.g., a UE), and the device receives control signaling including DCI scheduling a set of PDSCH transmissions, where the DCI includes an indication of a table row of a time domain resource allocation (TDRA) table, and the table row corresponding to multiple subsets of the set of PDSCH transmissions, such as a first subset of the set of PDSCH transmissions and a second subset of the set of PDSCH transmissions that are non-overlapping sets of PDSCH transmissions. The UE receives the set of PDSCH transmissions, and can then transmit a respective HARQ-ACK corresponding to respective one or more of the multiple subsets of the set of PDSCH transmissions.

In some implementations of the method and apparatuses described herein, the DCI includes an indication as to whether the first subset of the PDSCH transmissions occurs prior to the second subset of the PDSCH transmissions. The UE can generate a first set of HARQ-ACK corresponding to the first subset of the set of PDSCH transmissions, and generate a second set of HARQ-ACK corresponding to the second subset of the set of PDSCH transmissions. The UE can generate the first set of HARQ-ACK based on a first priority, and generate the second set of HARQ-ACK based on a second priority different than the first priority. Alternatively or in addition, the UE can generate the first set of HARQ-ACK based on a first bundling group indication, and generate the second set of HARQ-ACK based on a second bundling group indication. Alternatively or in addition, the UE can generate the first set of HARQ-ACK based on a first maximum number of HARQ-ACK bundling groups, and generate the second set of HARQ-ACK based on a second maximum number of HARQ-ACK bundling groups. The UE can also divide the first subset of the set of PDSCH transmissions into a first number of PDSCH sub-groups based on the first maximum number of HARQ-ACK bundling groups, and divide a second subset of the set of PDSCH transmissions into a second number of PDSCH sub-groups based on the second maximum number of HARQ-ACK bundling groups.

Further, the UE can generate an acknowledgement (ACK) as a HARQ-ACK information bit of a PDSCH sub-group if all of the PDSCH transmissions of the PDSCH sub-group are correctly received, or generate a negative acknowledgment (NACK) as the HARQ-ACK information bit of the PDSCH sub-group if not all of the PDSCH transmissions of the PDSCH sub-group are correctly received. The UE can generate a first set of HARQ-ACK corresponding to a first subset of the set of PDSCH transmissions based on a first priority indication in the DCI, and generate a second set of HARQ-ACK corresponding to a second subset of the set of PDSCH transmissions based on a second priority indication different than the first priority indication. The second priority indication can be a pre-determined value equivalent to the first priority indication indicated in the DCI, or the first priority indication has a high priority index of one, and the second priority indication has a low priority index of zero. The UE can generate a first set of HARQ-ACK corresponding to the first subset of the set of PDSCH transmissions based on a first parameter, and generate a second set of HARQ-ACK corresponding to the second subset of the set of PDSCH transmissions based on a second parameter different than the first parameter, where the first parameter and the second parameter are indicated by higher layer signaling.

Some implementations of the method and apparatuses described herein may include wireless communication at a device (e.g., a UE), and the device receives control signaling including DCI scheduling a set of physical uplink shared channel (PUSCH) transmissions, where the DCI includes an indication of a table row of a TDRA table, and the table row corresponding to multiple subsets of the set of PUSCH transmissions, such as non-overlapping sets of the PUSCH transmissions. The UE can generate a first subset of the set of the PUSCH transmissions based on a first priority, and generate a second subset of the set of the PUSCH transmissions based on a second priority different than the first priority. The second priority indication may be a pre-determined value equivalent to the first priority indication indicated in the DCI, or the first priority indication has a high priority index of one, and the second priority indication has a low priority index of zero.

In some implementations of the method and apparatuses described herein, the device can generate the first subset of the set of PUSCH transmissions based on a first parameter, and generate the second subset of the set of PUSCH transmissions based on a second parameter different than the first parameter, where the first parameter and the second parameter are indicated by higher layer signaling. The table row of the TDRA table can include two sub-rows, and each of the sub-rows indicates time-domain resource allocation for a subset of the set of PUSCH transmissions. The device can determine indices of the two sub-rows based on an index of the table row of the TDRA table and a configured number of the sub-rows associated with the TDRA table.

Some implementations of the method and apparatuses described herein may include wireless communication at a network device (e.g., a base station, gNB), and the device transmits control signaling including DCI to schedule a set of PDSCH transmissions for a UE, where the DCI includes an indication of a table row of a TDRA table, and the table row corresponding to multiple subsets of the set of PDSCH transmissions. The base station transmits the set of PDSCH transmissions to the UE, and receives a respective HARQ-ACK corresponding to respective one or more of the multiple subsets of the set of PDSCH transmissions.

In some implementations of the method and apparatuses described herein, the base station can receive a first set of HARQ-ACK corresponding to a first subset of the set of PDSCH transmissions, and receive a second set of HARQ-ACK corresponding to a second subset of the set of PDSCH transmissions. The first set of HARQ-ACK can be based on a first priority, and the second set of HARQ-ACK based on a second priority different than the first priority. Alternatively or in addition, the first set of HARQ-ACK can be based on a first bundling group indication, and the second set of HARQ-ACK based on a second bundling group indication. Alternatively or in addition, the first set of HARQ-ACK can be based on a first maximum number of HARQ-ACK bundling groups, and the second set of HARQ-ACK based on a second maximum number of HARQ-ACK bundling groups.

### BRIEF DESCRIPTION OF THE DRAWINGS

Various aspects of the present disclosure for multi-channel scheduling are described with reference to the following Figures. The same numbers may be used throughout to reference like features and components shown in the Figures.

FIG. 1 illustrates an example of a wireless communications system that supports multi-channel scheduling in accordance with aspects of the present disclosure.

FIG. 2 illustrates an example of a TDRA table that supports multi-channel scheduling, and may be utilized in the wireless communications system, in accordance with aspects of the present disclosure.

FIG. 3 illustrates an example block diagram of components of a device (e.g., a UE) that supports multi-channel scheduling in accordance with aspects of the present disclosure.

FIG. 4 illustrates an example block diagram of components of a device (e.g., a base station) that supports multi-channel scheduling in accordance with aspects of the present disclosure.

FIGS. 5-11 illustrate flowcharts of methods that support multi-channel scheduling in accordance with aspects of the present disclosure.

### DETAILED DESCRIPTION

Implementations of multi-channel scheduling are described, such as for PDSCH scheduling and physical uplink shared channel (PUSCH) scheduling as related to XR services. The XR services encompass different types of digitally-enhanced realities, including VR, AR, and mixed reality MR, and refers to and includes all real and virtual combined environments, as well as human-machine interactions generated by computer technology and wearables. The techniques described in this disclosure are mechanisms that enable a UE determining one or two PDSCH groups based on the TDRA indication in a DCI. The UE can determine the PDSCH groups based on a RIV-like indication of the rows of the TDRA table, and determine priority for the first and the second PDSCH groups (or the priority of the corresponding HARQ-ACK for the first and the second PDSCH groups) based on the DCI. The UE can also determine whether and how to bundle HARQ-ACK for the first and the second PDSCH groups, which may be based on higher layer or physical layer indications.

Many types of XR and cloud gaming use cases are characterized by quasi-periodic traffic, with possible jitter, given the high data rate in a downlink video stream combined with the frequent uplink updates, such as for user pose and control updates, and the uplink video stream. Both the downlink and the uplink data traffic are also characterized by a relatively strict packet delay budget (PDB). The set of anticipated XR and CG services poses a variety or characteristics of the data uplink and downlink video streams, and may change “on-the-fly” while the services are running over NR. The XR data traffic characteristics (e.g., variable packet arrival rates with packets received at 30-120 frames per second with some jitter; packets having variable and large packet size; B and P-frames being dependent on I-frames; and the presence of multiple traffic and data flows such as for pose and video scene in uplink) can enable more efficient XR service delivery, such as in terms of satisfying the XR service requirements for a greater number of UEs, or in terms of UE power saving.

For high subcarrier spacing (SCS) (e.g., 960 KHz) associated with large bandwidth and short slot duration, a single DCI can schedule multiple uplink or downlink transport blocks (TBs) to keep PDCCH blind decoding and CCE budget feasible while still being able to support PDCCH candidates with large aggregation levels (e.g., with 16 CCEs). Assuming multiple contiguous slots can have highly correlated channels (due to small slot duration, and assuming interference is also highly correlated over those slots) and to save feedback overhead, HARQ-ACK corresponding to each group of the multiple downlink TBs can be bundled, where PDSCH groups and/or PUSCH groups are determined based on a radio resource control (RRC) configured number of bundling groups. Additional information on the running services from higher layers, such as the quality of service (QoS) flow association, frame-level QoS, ADU-based QoS, XR specific QoS, etc., can be utilized and is beneficial to facilitate informed choices of radio parameters. Notably, the XR application awareness by both a UE and gNB would improve the user experience, improve the NR system capacity in supporting XR services, and reduce the UE power consumption.

As related to XR services, large video frames of XR data traffic can be transmitted using a carrier with high SCS to satisfy the latency and reliability requirements of the XR data traffic. In XR, a video frame can be an I-frame, P-frame, or can be composed of I-slices, and/or P-slices. The I-frames or I-slices are more important and larger than P-frames or P-slices. Aspects of the techniques described in this disclosure enhance multiple uplink or downlink TB scheduling, taking into consideration the differences between I-frames or I-slices, and P-frames or P-slices. The techniques provide that a UE can distinguish PDSCHs and/or PUSCHs corresponding to an I-slice from PDSCHs and/or PUSCHs corresponding to a P-slice when a DCI schedules a video frame comprising an I-slice and a P-slice, and the UE can determine HARQ-ACK and/or PUSCH priority, as well as HARQ-ACK bundling for each PDSCH group. In particular, the UE can determine one or two PDSCH groups (e.g., one PDSCH group corresponding to I-frames or I-slices, and one PDSCH group corresponding to P-frames or P-slices) based on a TDRA indication in a DCI. The UE can determine a priority for the first and the second PDSCH groups based on the DCI, and also determine whether and how to bundle HARQ-ACK for the first and the second PDSCH groups based on higher layer or physical layer indications.

Aspects of the disclosure include a UE can receive a TDRA indication in a DCI scheduling a set of PDSCHs or PUSCHs, where the set of PDSCHs or PUSCHs can be associated with one or two groups. A UE can determine two rows of a TDRA table based on the TDRA indication, and one PDSCH group or PUSCH group can be associated to none, one, or two rows of the two rows of the TDRA table. A UE can generate a HARQ-ACK in response to the PDSCHs, or a PUSCH according to the determined two groups. A UE can determine priority of each group based on a priority indication in the DCI. A UE can also determine whether to bundle the HARQ-ACK for each PDSCH group, and in response to determining to bundle the HARQ-ACK for a PDSCH group, the UE determines sub-groups for which the HARQ-ACK is to be bundled. Further, in some of the described implementations, rather than uplink or downlink transmissions and the corresponding PDSCH or PUSCH grouping into two or more groups scheduled via a DCI, multiple sidelink transmissions can be scheduled and grouped via a grant (SCI or DCI), or a first network node may schedule and group multiple transmissions to or from a second network node (IAB relays).

Aspects of the present disclosure are described in the context of a wireless communications system. Aspects of the present disclosure are further illustrated and described with reference to device diagrams and flowcharts that relate to multi-channel scheduling.

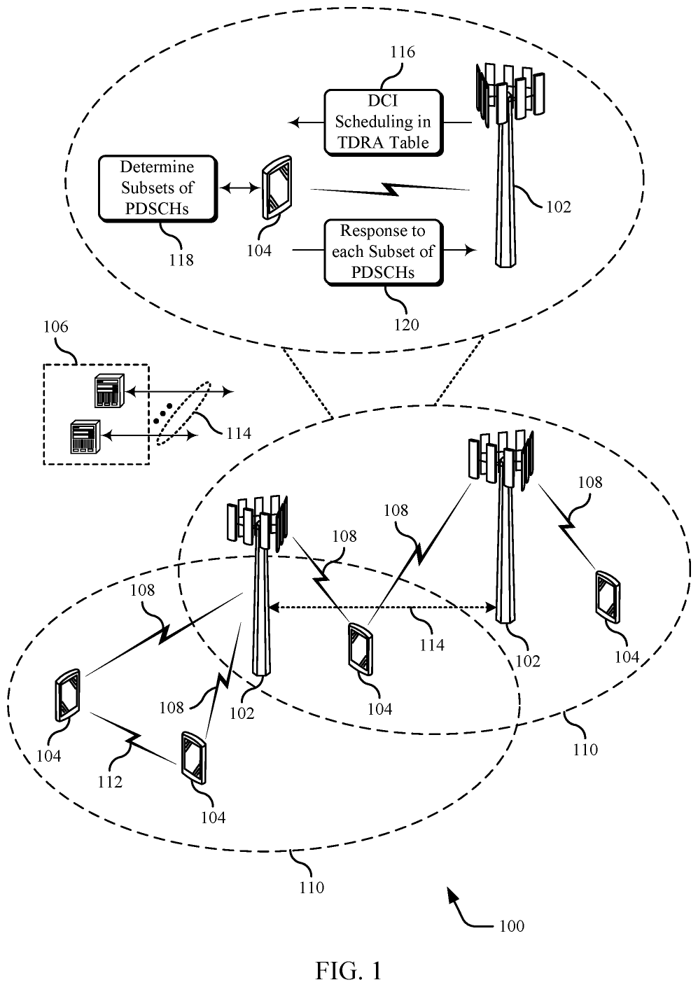

FIG. 1 illustrates an example of a wireless communications system 100 that supports multi-channel scheduling in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 118 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, one or more of the UEs 104 and base stations 102 are operable to implement various aspects of multi-channel scheduling, as described herein. For instance, a base station 102 can communicate DCI 116 that schedules a set of PDSCH transmissions at a UE 104, and the DCI 116 includes an indication of a table row of a TDRA table. The UE 104 receives the DCI 116 and performs an operation 118 to determine multiple subsets (e.g., two subsets) of the set of PDSCH transmissions based on the table row of the TDRA table. The UE 104 can then receive the set of PDSCH transmissions from the base station 102, and accordingly, the UE 104 generates a response 120 as a HARQ-ACK corresponding to each of the multiple subsets of the set of PDSCH transmissions, which is transmitted to the base station 102. The techniques described in this disclosure are mechanisms that enable the UE 104 to determine one or two PDSCH groups based on the TDRA indication in a DCI. In an implementation, the UE 104 can determine the PDSCH groups based on a RIV-like indication of the rows of the TDRA table, and determine priority for first and second PDSCH groups (or priority for HARQ-ACK corresponding to the first and second PDSCH groups) based on the DCI. The UE 104 can also determine whether and how to bundle HARQ-ACK for the first and second PDSCH groups.

In the 3^{rd} Generation Partnership Project (3GPP) (release 17), a UE can be scheduled via a PDCCH for multiple downlink PDSCH receptions or multiple uplink PUSCH transmissions over multiple slots. A HARQ-ACK corresponding to the scheduled PDSCHs can be bundled into multiple bundling groups. If a UE is provided numberOfHARQ-BundlingGroups for a serving cell c, the UE generates HARQ-ACK information over transport block groups (TBGs) for PDSCH receptions where, for a maximum number of N_{PDSCH}^{max} PDSCH receptions scheduled by a DCI format on the serving cell, a maximum number of TBGs N_{HARQ-ACK,c}^{TBG,max} is provided by numberOfHARQ-BundlingGroups. If the UE detects a DCI format scheduling N_{PDSCH,c} PDSCH receptions on the serving cell c, the UE generates N_{HARQ-ACK,c}^{TBG,max} HARQ-ACK information bits for first TBs and, if applicable, generates N_{HARQ-ACK,c}^{TBG,max} HARQ-ACK information bits for second TBs in the N_{PDSCH} PDSCH receptions as described in the next paragraph by setting N_{HARQ-ACK}^{CBG/TB,max}=N_{HARQ-ACK,c}^{TBG,max} and C=N_{PDSCH,c}, and by replacing CBG with TBG. If a UE is provided PDSCH-TimeDomainResourceAllocationListForMultiPDSCH and, if provided, numberOfHARQ-BundlingGroups with value N_{HARQ-ACK}^{TBG,max}>1 for N_{cells}^{DL,TBG} serving cells. If a UE is not provided PDSCH-TimeDomainResourceAllocationListForMultiPDSCH or is provided numberOfHARQ-BundlingGroups with value N_{HARQ-ACK}^{TBG,max}=1, for N_{cells}^{DL,TB} serving cells where N_{cells}^{DL,TB}+N_{cells}^{DL,TBG}=N_{cells}^{DL}.

The UE generates an ACK for the HARQ-ACK information bit of a CBG if the UE correctly received all code blocks of the CBG and generates a NACK for the HARQ-ACK information bit of a CBG if the UE incorrectly received at least one code block of the CBG. If the UE receives two transport blocks, the UE concatenates the HARQ-ACK information bits for CBGs of the second transport block after the HARQ-ACK information bits for CBGs of the first transport block. The HARQ-ACK codebook includes the N_{HARQ-ACK}^{CBG/TB,max} HARQ-ACK information bits and, if N_{HARQ-ACK}^{CBG/TB}<N_{HARQ-ACK}^{CBG/TB,max} for a transport block, the UE generates a NACK value for the last N_{HARQ-ACK}^{CBG/TB,max}−N_{HARQ-ACK}^{CBG/TB} information bits for the transport block in the HARQ-ACK codebook. If the UE generates a HARQ-ACK codebook in response to a retransmission of a transport block, corresponding to a same HARQ process as a previous transmission of the transport block, the UE generates an ACK for each CBG that the UE correctly decoded in a previous transmission of the transport block. If a UE correctly detects each of the N_{HARQ-ACK}^{CBG/TB} CBGs and does not correctly detect the transport block for the N_{HARQ-ACK}^{CBG/TB} CBGs, the UE generates a NACK value for each of the N_{HARQ-ACK}^{CBG/TB} CBGs.

Extended reality (XR) refers to all real and virtual combined environments, as well as human-machine interactions generated by computer technology and wearables. It includes representative forms of augmented reality (AR), mixed reality (MR), and virtual reality (VR), as well as the areas interpolated among them. The levels of virtuality range from partially sensory inputs to fully immersive VR. A key aspect of XR is the extension of human experiences, particularly relating to the senses of existence, as represented by VR, and the acquisition of cognition, as represented by AR.

Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided.

Augmented reality (AR) is when a user is provided with additional information or artificially generated items or content overlaid upon their current environment. Such additional information or content will usually be visual and/or audible and their observation of the current environment may be direct, with no intermediate sensing, processing, and rendering, or indirect, where the perception of the environment is relayed via sensors and may be enhanced or processed. Mixed reality (MR) is an advanced form of AR where some virtual elements are inserted into the physical scene with the intent to provide the illusion that these elements are part of the real scene.

Many types of XR and cloud gaming use cases are characterized by quasi-periodic traffic, with possible jitter, given the high data rate in a downlink video stream combined with the frequent uplink updates, such as for user pose and control updates, and the uplink video stream. Both the downlink and the uplink data traffic are also characterized by a relatively strict packet delay budget (PDB). The set of anticipated XR and CG services poses a variety or characteristics of the data uplink and downlink video streams, and may change “on-the-fly” while the services are running over NR. Therefore, additional information on the running services from higher layers, such as the quality of service (QoS) flow association, frame-level QoS, ADU-based QoS, XR specific QoS, etc., can be utilized and is beneficial to facilitate informed choices of radio parameters. Notably, the XR application awareness by both a UE and gNB would improve the user experience, improve the NR system capacity in supporting XR services, and reduce the UE power consumption.

Data packets within a frame may have dependency on or with each other since an application running on a UE typically needs all of these packets for decoding the frame. Hence one packet loss will render the other correlative packets useless even if they are successfully transmitted. For example, XR applications impose requirements in terms of media units (e.g., ADUs), rather than in terms of single packets or packet data units (PDUs). An ADU is the smallest unit of data processed independently by an application, such as processing for handling out-of-order traffic data (e.g., out of order ADU handling). In addition to ADUs, other media units, such as video and/or audio frames or/tiles, and control information, can be used, where media units consist of PDUs that have the same QoS requirements.

The HARQ-ACK bundling can be performed across all PDSCHs scheduled by a single DCI or across bundling groups (or subsets) of PDSCHs scheduled by the same DCI. The number of bundling groups can be configured, additionally or alternatively, the number of PDSCHs per bundling group can be configured, additionally or alternatively the time duration of a bundling group can be configured. A time domain bundling pattern can be defined via radio resource control (RRC) configuration or medium access control (MAC) control element (CE) (MAC-CE). For example, the number of ACK/NACK (A/N) bits can be defined per DCI, and if the number of PDSCHs is greater than the number of A/N bits per DCI, then some of PDSCHs can be bundled together. For example, if the number A/N bits per DCI is four and eight PDSCHs were scheduled by the DCI, then A/N of each two PDSCHs will be bundled together. A more dynamic approach can be attained by allowing the PDCCH (DCI) to carry an explicit indication of the number of A/N bits for all upcoming DCI within one A/N occasion, where the HARQ-ACK feedback in response to the upcoming DCIs are provided in the one A/N occasion. Notably, the previous solutions have not proposed to determine two (or more) PDSCH groups from ‘N’ PD(U)SCHs scheduled via a DCI based on the indicated row of time domain resource allocation (TDRA) table in the DCI.

Aspects of the present disclosure include solutions for multi-channel scheduling, such for PDSCH scheduling and PUSCH scheduling as related to XR services. The XR services encompass different types of digitally-enhanced realities, including VR, AR, and mixed reality MR, and refers to and includes all real and virtual combined environments, as well as human-machine interactions generated by computer technology and wearables. As described throughout this disclosure, the concept of a video slice and a video frame is used interchangeably, whereas according to hybrid video codecs performing spatial and temporal compression specifications (e.g., H.26x family of MPEG video codecs and the like), a slice is a raster-scan partition of a frame. As such, a slice can form a portion of a frame or an entire frame. The relevant examples and described implementations are not limited to the concept of a frame, but rather, can be generally discussed from a slice perspective. The term slice may be used interchangeably or instead of the term frame, and also encompasses an interleaved traffic model where intra-coded and predicted (I/P) slices are mixed in a video frame.

Aspects of the disclosure include a UE can receive a TDRA indication in a DCI scheduling a set of PDSCHs or PUSCHs, where the set of PDSCHs or PUSCHs can be associated with one or two groups. A UE can determine two rows of a TDRA table based on the TDRA indication, and one PDSCH group or PUSCH group can be associated to none, one, or two rows of the two rows of the TDRA table. A UE can generate a HARQ-ACK in response to the PDSCHs, or a PUSCH according to the determined two groups. A UE can determine priority of each group based on a priority indication in the DCI. A UE can also determine whether to bundle the HARQ-ACK for each PDSCH group, and in response to determining to bundle the HARQ-ACK for a PDSCH group, the UE determines sub-groups for which the HARQ-ACK is to be bundled. Further, in some of the described implementations, rather than uplink or downlink transmissions and the corresponding PDSCH or PUSCH grouping into two or more groups scheduled via a DCI, multiple sidelink transmissions can be scheduled and grouped via a grant (SCI or DCI), or a first network node may schedule and group multiple transmissions to or from a second network node (IAB relays).

In aspects of this disclosure, TDRA table enhancement is taken into consideration. For a TDRA in a DCI that can schedule multiple PDSCHs or PUSCHs, a row of the TDRA table can indicate PDSCHs or PUSCHs that are in consecutive or non-consecutive slots, by configuring {start and length indicator value (SLIV), mapping type, scheduling offset K0 (or K2)} for each PDSCH or PUSCH in the row of the TDRA table. In implementation scenarios, a gNB can schedule uplink and/or downlink transmissions which may include both I-frame/slice and P-frame/slice, or transmissions with different priorities, and the boundaries of an I-frame/slice and P-frame/slice can be indicated in the corresponding TDRA table. In a first described implementation, a UE is configured with an M-number (e.g., two or more) of PDSCH groups. In a second described implementation, a UE is configured with HARQ-ACK bundling groups.

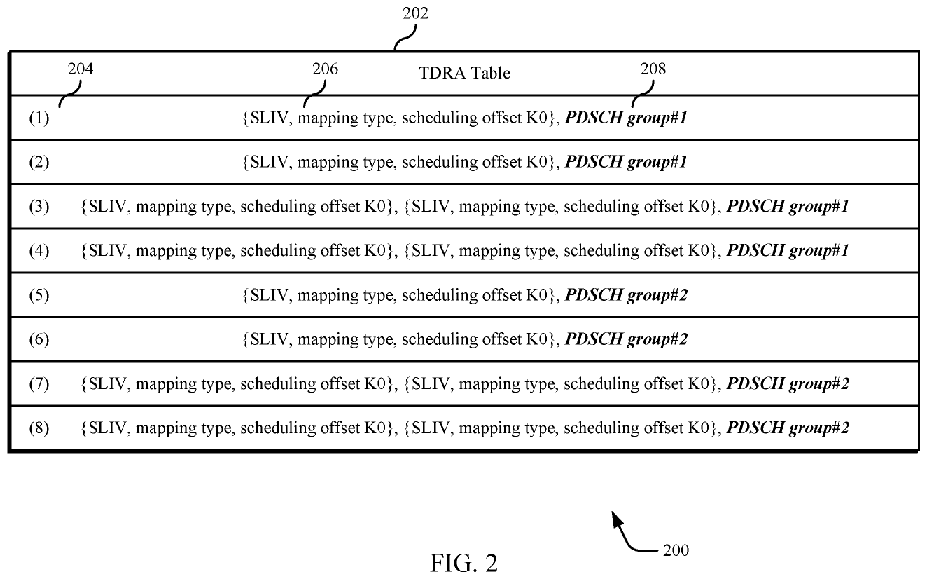

FIG. 2 illustrates an example 200 of a TDRA table 202 that supports multi-channel scheduling in accordance with aspects of the present disclosure. In this example, the TDRA table 202 has eight sub-rows 204, where each sub-row corresponds to one or two PDSCHs associated to one of the first or second PDSCH groups. An index and the number of the sub-rows is indicated to the UE (e.g., in DCI and/or in a higher layer signal), from which the UE can determine two sub-rows corresponding to scheduled PDSCHs scheduled via a DCI. The techniques described in this disclosure are mechanisms that enable a UE determining one or two PDSCH groups based on the TDRA indication in a DCI. In an implementation, a UE can determine the PDSCH groups based on a RIV-like indication of the rows of the TDRA table, and determine priority for the first and the second PDSCH groups based on the DCI. The UE can also determine whether and how to bundle HARQ-ACK for the first group, and whether and how to bundle HARQ-ACK for the second group based on higher layer or physical layer indications. In an example, the DCI may indicate a TDRA table index identifying a TDRA table that corresponds to the scheduled transmissions (e.g., a first TDRA table may be associated with scheduling a single PDSCH transmission and a second TDRA table may be associated with scheduling more than one PDSCH transmissions).

The TDRA table 202 includes the sub-rows 204 and the sub-row scheduling parameters 206, such as the following information for each PDSCH of the set of scheduled PDSCHs: a SLIV (starting position of transmission and the length of the transmission), the mapping type of the transmission (e.g., in terms of whether it's sub-slot based (DMRS)), scheduling offsets between the DCI and the PDSCH transmission, and the time gap between the two. The sub-row scheduling parameters 206 in the enhanced TDRA table 202 also indicate the PDSCH group number 208 for each of the sub-rows.

In the first implementation, a UE is configured with an M-number (e.g., two or more) of PDSCH groups. The UE receives a DCI indicating a row of a TDRA table, and can determine, based on the row of the TDRA table, an N-number of PDSCHs with their corresponding {SLIV, mapping type, scheduling offset K0 (or K2)} for each PDSCH (or PUSCH) in the row of the TDRA table. The UE can determine up to an M-number of non-overlapping partitions of the set of ‘N’ PDSCHs (or PUSCHs), based on the row of the TDRA table, where each partition comprises a set of consecutively scheduled PDSCHs (or PUSCHs). The UE also receives the ‘N’ PDSCHs according to the determined ‘M’ non-overlapping partitions, or the UE also transmits ‘N’ PUSCHs according to the determined ‘M’ non-overlapping partitions.

In further examples and details, the M-number of non-overlapping partitions (M=2), where a first group includes PDSCHs associated with an I-frame or slice, and a second group includes PDSCHs associated with a P-frame or slice. A row of the TDRA table can indicate ‘N’=4 PDSCHs, where the first two PDSCHs belong to an I-frame or slice and the last two PDSCHs belong to a P-frame or slice, and the TDRA table row comprises {SLIV0, mapping type0, scheduling offset K0_0},{SLIV1, mapping type1, scheduling offset K0_1},Boundary_I2P, {SLIV2, mapping type2, scheduling offset K0_2},{SLIV3, mapping type3, scheduling offset K0_3}, where {SLIV0, mapping type0, scheduling offset K0_0},{SLIV1, mapping type1, scheduling offset K0_1} correspond to the first two PDSCHs that are associated with the I-slice (first PDSCH group), the Boundary_I2P indicates that the first group of PDSCHs is ended and the second group of PDSCHs is started, and {SLIV2, mapping type2, scheduling offset K0_2},{SLIV3, mapping type3, scheduling offset K0_3} correspond to the last two PDSCHs that are associated with the P-slice (second PDSCH group). Similarly, a row of the TDRA table can indicate ‘N’=4 PDSCHs, where the first three PDSCHs belong to a P-frame or slice and the last PDSCH belongs to an I-frame or slice, and the TDRA table row comprises {SLIV0, mapping type0, scheduling offset K0_0},{SLIV1, mapping type1, scheduling offset K0_1}, {SLIV2, mapping type2, scheduling offset K0_2}, Boundary_P2I, {SLIV3, mapping type3, scheduling offset K0_3}, where the Boundary_P2I indicates that the second group of PDSCHs is ended and the first group of PDSCHs is started. If the row of the TDRA table does not include Boundary_I2P or Boundary_P2I, the UE can determine one partition (i.e., all ‘N’ PDSCHs belong to the same group (e.g., I-frame or P-frame)).

As a motivation for indicating the partition boundary, the partitioning can be utilized by the UE in performing frame or slice-specific actions, such as to separate and/or distinguish HARQ-ACK bundling for an I-frame or slice, and for a P-frame or slice, or for different ADUs scheduled by the same DCI. In alternative implementations, the UE can receive a DCI scheduling a set of PUSCHs, rather than PDSCHs. The UE can be configured (e.g., via RRC configuration) or dynamically indicated (e.g., via DCI or MAC-CE) as to whether the UE should bundle HARQ-ACK for each PDSCH group separately. The DCI can contain a priority indicator field of ‘M’ bits, and each bit of the priority indicator field applies to a corresponding PDSCH group. The DCI can contain a priority indicator field of 1 bit, and the priority indicator field applies to the first PDSCH group (or second PDSCH group). The DCI can contain the priority indicator field of one bit, and if the field has value ‘1’ (high priority), then the priority indicator field applies to the first PDSCH group. Alternatively, if the field has value ‘0’ (low priority), then the priority indicator field applies to both the first PDSCH group and the second PDSCH group.

The UE can be configured with a M-bit priority indicator field in a DCI format that schedules a plurality of PDSCHs or PUSCHs, where each bit of the M-bit field indicates a physical layer (PHY) priority of each PDSCH group for corresponding HARQ-ACK information (when DCI includes downlink assignments), or a physical layer priority of each PUSCH group (when DCI includes uplink grants). When different PHY priorities among PDSCH groups are indicated, a UE is not expected to bundle HARQ-ACK information of the PDSCH groups of different PHY priorities. In one implementation, the UE performs HARQ-ACK bundling only for a PDSCH group of lower PHY priority (e.g. priority index 0) and does not perform HARQ-ACK bundling for a PDSCH group of higher PHY priority (e.g. priority index 1) for finer granularity of HARQ-ACK feedback.

The Boundary_P2I and Boundary_I2P can be indicated by special combinations of {SLIV, mapping type, scheduling offset K0}. The UE can determine the boundary between the two PDSCH groups (‘M’=2) based on a single boundary indication (e.g., instead of two possible boundary indications: Boundary_P2I and Boundary_I2P), and the priority indication in the DCI. The UE can be configured with a two-bit priority indicator field in a DCI format scheduling the PDSCH groups. The indicated row of the TDRA table in the DCI can indicate ‘N’=4 PDSCHs, {SLIV0, mapping type0, scheduling offset K0_0},{SLIV1, mapping type1, scheduling offset K0_1},Boundary, {SLIV2, mapping type2, scheduling offset K0_2},{SLIV3, mapping type3, scheduling offset K0_3}, where the priority indicator field in the DCI is two-bits. For example, the priority indication field indicates two-bits ‘10’ (high, low), and the UE determines the first two PDSCHs (that are before the “Boundary”) are associated to the first PDSCH group (since ‘1’ is indicated in the first bit of the priority indication), and the last two PDSCHs (that are before the “Boundary”) are associated to the second PDSCH group (since ‘0’ is indicated in the second bit of the priority indication). In another example, the priority indication field indicates ‘01’ (low, high), and the UE determines the first two PDSCHs are associated to the second PDSCH group (since ‘0’ is indicated in the first bit of the priority indication), and the second PDSCHs are associated to the first PDSCH group (since ‘1’ is indicated in the second bit of the priority indication).

In an implementation, a row of the TDRA table may be comprised of ‘M’ sub-rows (e.g., ‘M’=2), and each sub-row is associated to one PDSCH group. The UE can determine two sub-row indices based on the received TDRA row index in the DCI. To determine the sub-row indices from the TDRA row index, the UE can utilize a RIV-like approach, corresponding to a starting sub-row index and a length in terms of contiguous sub-rows. Additionally, one bit in the DCI may indicate whether the PDSCHs of the first PDSCH group are scheduled prior to the PDSCHs of the second PDSCH group. Labeling the first to-be determined sub-row index i1, and the second to-be determined sub-row index i2, if (L−1)≤└Ns/2┘, then: RIV=Ns(L−1)+ss, else: RIV=Ns(Ns−L+1)+(Ns−1−ss); where RIV is the indicated TDRA row index, Ns is the number of sub-rows, i1=ss (the first to-be determined sub-row index) and L is the gap length from ss (i2=ss+L is the index of the second to-be determined sub-row index). For RIV=10, and Ns=64: then L=1, ss=10 leading to i1=10, i2=11. For RIV=100, and Ns=64: then L=64, ss=27 leading to i1=27, i2=91. For RIV=700, and Ns=64: then L=55, ss=3 leading to i1=3, i2=58. In an example of 64 total sub-rows, the first 32 sub-rows belong to the first PDSCH group, and the last 32 sub-rows belong to the second PDSCH group. For RIV=10, corresponding to sub-row indices 10, and 11, both sub-rows belong to the first PDSCH group. For RIV=100, corresponding to sub-row indices 27, and 91, the sub-row ‘27’ belongs to the first PDSCH group, and the sub-row ‘91’ belongs to the second PDSCH group. In another example, each sub-row has a PDSCH group index. In another example, a higher-layer parameter (or alternatively/additionally a physical layer parameter) indicates an index ‘W’, where the first ‘W’ sub-rows belong to a first PDSCH (or PUSCH) group and the remaining sub-rows belong to a second PDSCH (or PUSCH) group.

In the second implementation, a UE is configured with a first maximum number of HARQ-ACK bundling groups (Q1). The UE receives a DCI scheduling multiple (e.g., more than two) PDSCHs having more than two transport blocks (TBs) in total. The UE can determine a first group of PDSCHs of the multiple PDSCHs, where the cardinality of the first group of PDSCH is N1, and determine a second group of PDSCHs of the multiple PDSCHs, where the cardinality of the second group of PDSCH is N2. The UE can determine whether to perform HARQ-ACK bundling for the first group of PDSCHs and determine whether to perform HARQ-ACK bundling for the second group of PDSCHs. In response to the determining HARQ-ACK bundling for the first group of PDSCHs, the UE can determine a second maximum number of HARQ-ACK bundling groups (Q2) for the first PDSCH group. In response to determining HARQ-ACK bundling for the second group of PDSCHs, the UE can determine a third maximum number of HARQ-ACK bundling groups (Q3) for the second PDSCH group.

The UE can generate Q2 HARQ-ACK information bits for first TBs (first TB of each PDSCH of the first PDSCH group) and, if applicable, generate Q2 HARQ-ACK information bits for second TBs (second TB of each PDSCH of the first PDSCH group) in the first PDSCH group. The UE determines M1=min(Q2, N1); divides the first PDSCH group into M1 PDSCH sub-groups (e.g., for Q2=3, N1=6 PDSCHs; M1=3; Sub-group 1: (PDSCH1, PDSCH2), Sub-group 2: (PDSCH3, PDSCH4), and Sub-group 3: (PDSCH5, PDSCH6)); and generates an ACK for the HARQ-ACK information bit of a sub-group if the UE correctly received all PDSCHs of the sub-group. The UE generates a NACK for the HARQ-ACK information bit of the sub-group if the UE incorrectly received at least one PDSCH of the sub-group. If the UE receives two transport blocks for a PDSCH, the UE concatenates the HARQ-ACK information bits for sub-groups of the second transport block after the HARQ-ACK information bits for the sub-groups of the first transport block. Alternatively, the UE concatenates the HARQ-ACK information bit for each sub-group of the second transport block after the HARQ-ACK information bit for the corresponding sub-group of the first transport block. Similarly, the UE can generate Q3 HARQ-ACK information bits for first TBs and, if applicable, generate Q3 HARQ-ACK information bits for second TBs in the second PDSCH group.

Further examples and details include the first, second, and third maximum number of HARQ-ACK bundling groups are the same. The UE can be configured with a fourth maximum number of HARQ-ACK bundling groups (Q4), where Q2=Q1, and Q3=Q4. As motivation, an I-frame or slice and a P-frame or slice can have different sizes, potentially leading to a different number of PDSCHs (N1 is different than N2), and multiple PDSCHs having both an I-frame or slice and a P-frame or slice scheduled by a single DCI, which may benefit (e.g., in terms of re-transmission efficiency) from having a different number of PDSCHs within a HARQ-ACK bundle. The UE may determine Q2 and/or Q3 based on a MAC-CE indication, where the MAC-CE indication is included in a PDSCH that is scheduled via the DCI. If the UE cannot decode the PDSCH containing the MAC-CE, the UE would use a default bundling size, such as the default bundling size is applicable to all PDSCHs scheduled by the DCI, and the MAC-CE is sent in a pre-determined PDSCH (e.g., in a first or last PDSCH of the multiple PDSCHs). The UE can determine the first group of PDSCHs and the second group of PDSCHs of the multiple PDSCHs based on the DCI, where the UE determines the first group of PDSCHs and the second group of PDSCHS of the multiple PDSCHs based on the TDRA field in the DCI. The UE can also determine whether to perform HARQ-ACK bundling for the first group of PDSCHs and whether to perform HARQ-ACK bundling for the second group of PDSCHs based on the DCI, based on a MAC-CE indication, or based on a RRC signaling.

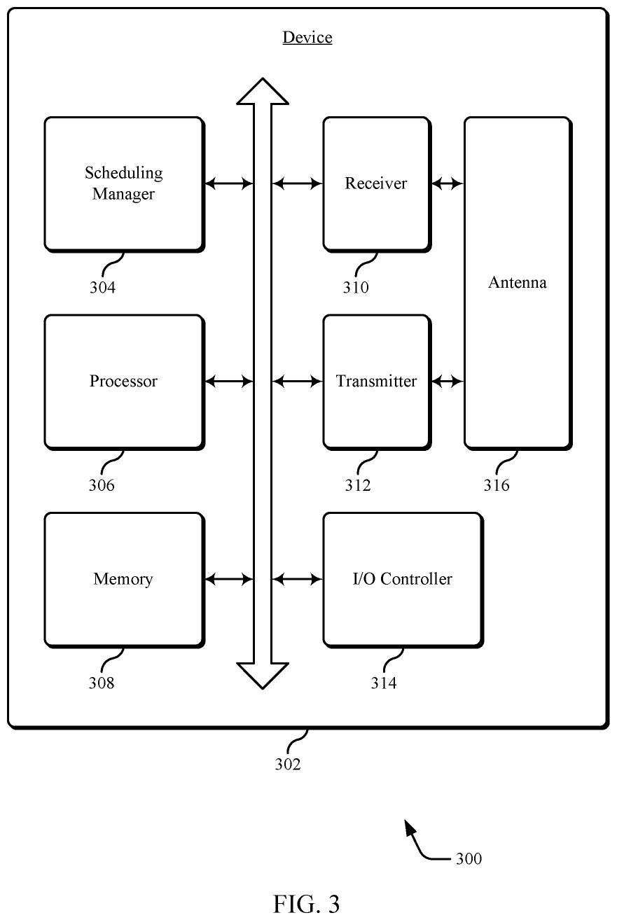

FIG. 3 illustrates an example of a block diagram 300 of a device 302 that supports multi-channel scheduling in accordance with aspects of the present disclosure. The device 302 may be an example of a UE 104 as described herein. The device 302 may support wireless communication and/or network signaling with one or more base stations 102, other UEs 104, network entities and devices, or any combination thereof. The device 302 may include components for bi-directional communications including components for transmitting and receiving communications, such as a scheduling manager 304, a processor 306, a memory 308, a receiver 310, a transmitter 312, and an I/O controller 314. These components may be in electronic communication or otherwise coupled (e.g., operatively, communicatively, functionally, electronically, electrically) via one or more interfaces (e.g., buses).

The scheduling manager 304, the receiver 310, the transmitter 312, or various combinations thereof or various components thereof may be examples of means for performing various aspects of the present disclosure as described herein. For example, the scheduling manager 304, the receiver 310, the transmitter 312, or various combinations or components thereof may support a method for performing one or more of the functions described herein.

In some implementations, the scheduling manager 304, the receiver 310, the transmitter 312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 306 and the memory 308 coupled with the processor 306 may be configured to perform one or more of the functions described herein (e.g., by executing, by the processor 306, instructions stored in the memory 308).

Additionally or alternatively, in some implementations, the scheduling manager 304, the receiver 310, the transmitter 312, or various combinations or components thereof may be implemented in code (e.g., as communications management software or firmware) executed by the processor 306. If implemented in code executed by the processor 306, the functions of the scheduling manager 304, the receiver 310, the transmitter 312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduling manager 304 may be configured to perform various operations (e.g., receiving, monitoring, transmitting) using or otherwise in cooperation with the receiver 310, the transmitter 312, or both. For example, the scheduling manager 304 may receive information from the receiver 310, send information to the transmitter 312, or be integrated in combination with the receiver 310, the transmitter 312, or both to receive information, transmit information, or perform various other operations as described herein. Although the scheduling manager 304 is illustrated as a separate component, in some implementations, one or more functions described with reference to the scheduling manager 304 may be supported by or performed by the processor 306, the memory 308, or any combination thereof. For example, the memory 308 may store code, which may include instructions executable by the processor 306 to cause the device 302 to perform various aspects of the present disclosure as described herein, or the processor 306 and the memory 308 may be otherwise configured to perform or support such operations.

For example, the scheduling manager 304 may support wireless communication and/or network signaling at a device (e.g., the device 302, a UE) in accordance with examples as disclosed herein. The scheduling manager 304 and/or other device components may be configured as or otherwise support an apparatus, such as a UE, including a transceiver; a processor coupled to the transceiver, the processor and the transceiver configured to cause the apparatus to: receive control signaling comprising downlink control information (DCI) scheduling a set of physical downlink shared channel (PDSCH) transmissions, the DCI comprising an indication of a table row of a time domain resource allocation (TDRA) table, and the table row corresponding to multiple subsets of the set of PDSCH transmissions; receive the set of PDSCH transmissions; and transmit a respective hybrid automatic repeat request acknowledgement (HARQ-ACK) corresponding to respective one or more of the multiple subsets of the set of PDSCH transmissions.

Additionally, the apparatus (e.g., a UE) includes any one or combination of: the processor and the transceiver are configured to cause the apparatus to determine the multiple subsets of the set of PDSCH transmissions comprising a first subset of the set of PDSCH transmissions and a second subset of the set of PDSCH transmissions. The first subset and the second subset of the set of PDSCH transmissions are non-overlapping sets of PDSCH transmissions. The DCI comprises an indication as to whether the first subset of the PDSCH transmissions occurs prior to the second subset of the PDSCH transmissions. The processor and the transceiver are configured to cause the apparatus to: generate a first set of HARQ-ACK corresponding to a first subset of the set of PDSCH transmissions; and generate a second set of HARQ-ACK corresponding to a second subset of the set of PDSCH transmissions. The processor and the transceiver are configured to cause the apparatus to: generate the first set of HARQ-ACK based at least in part on a first priority; and generate the second set of HARQ-ACK based at least in part on a second priority different than the first priority. The processor and the transceiver are configured to cause the apparatus to: generate the first set of HARQ-ACK based at least in part on a first bundling group indication; and generate the second set of HARQ-ACK based at least in part on a second bundling group indication. The processor and the transceiver are configured to cause the apparatus to: generate the first set of HARQ-ACK based at least in part on a first maximum number of HARQ-ACK bundling groups; and generate the second set of HARQ-ACK based at least in part on a second maximum number of HARQ-ACK bundling groups. The processor and the transceiver are configured to cause the apparatus to: divide a first subset of the set of PDSCH transmissions into a first number of PDSCH sub-groups based at least in part on the first maximum number of HARQ-ACK bundling groups; and divide a second subset of the set of PDSCH transmissions into a second number of PDSCH sub-groups based at least in part on the second maximum number of HARQ-ACK bundling groups. The processor and the transceiver are configured to cause the apparatus to: generate an acknowledgement (ACK) as a HARQ-ACK information bit of a PDSCH sub-group if all of the PDSCH transmissions of the PDSCH sub-group are correctly received; or generate a negative acknowledgment (NACK) as the HARQ-ACK information bit of the PDSCH sub-group if not all of the PDSCH transmissions of the PDSCH sub-group are correctly received. The processor and the transceiver are configured to cause the apparatus to: generate a first set of HARQ-ACK corresponding to a first subset of the set of PDSCH transmissions based at least in part on a first priority indication in the DCI; and generate a second set of HARQ-ACK corresponding to a second subset of the set of PDSCH transmissions based at least in part on a second priority indication different than the first priority indication. The second priority indication is a pre-determined value equivalent to the first priority indication indicated in the DCI; or the first priority indication has a high priority index of one, and the second priority indication has a low priority index of zero. The processor and the transceiver are configured to cause the apparatus to: generate a first set of HARQ-ACK corresponding to a first subset of the set of PDSCH transmissions based at least in part on a first parameter; and generate a second set of HARQ-ACK corresponding to a second subset of the set of PDSCH transmissions based at least in part on a second parameter different than the first parameter, the first parameter and the second parameter indicated by higher layer signaling. The table row of the TDRA table comprises two sub-rows, and each of the sub-rows indicates time-domain resource allocation for a subset of the set of PDSCH transmissions. The processor and the transceiver are configured to cause the apparatus to determine indices of the two sub-rows based on an index of the table row of the TDRA table and a configured number of the sub-rows associated with the TDRA table.

The scheduling manager 304 and/or other device components may be configured as or otherwise support a means for wireless communication and/or network signaling at a UE, including receiving control signaling comprising downlink control information (DCI) scheduling a set of physical downlink shared channel (PDSCH) transmissions, the DCI comprising an indication of a table row of a time domain resource allocation (TDRA) table, and the table row corresponding to multiple subsets of the set of PDSCH transmissions; receiving the set of PDSCH transmissions; and transmitting a respective hybrid automatic repeat request acknowledgement (HARQ-ACK) corresponding to respective one or more of the multiple subsets of the set of PDSCH transmissions.

Additionally, wireless communication and/or network signaling at the UE includes any one or combination of: determining the multiple subsets of the set of PDSCH transmissions comprising a first subset of the set of PDSCH transmissions and a second subset of the set of PDSCH transmissions. The first subset and the second subset of the set of PDSCH transmissions are non-overlapping sets of PDSCH transmissions. The DCI comprises an indication as to whether the first subset of the PDSCH transmissions occurs prior to the second subset of the PDSCH transmissions. The method further comprising: generating a first set of HARQ-ACK corresponding to a first subset of the set of PDSCH transmissions; and generating a second set of HARQ-ACK corresponding to a second subset of the set of PDSCH transmissions. The method further comprising: generating the first set of HARQ-ACK based at least in part on a first priority; and generating the second set of HARQ-ACK based at least in part on a second priority different than the first priority. The method further comprising: generating the first set of HARQ-ACK based at least in part on a first bundling group indication; and generating the second set of HARQ-ACK based at least in part on a second bundling group indication. The method further comprising: generating the first set of HARQ-ACK based at least in part on a first maximum number of HARQ-ACK bundling groups; and generating the second set of HARQ-ACK based at least in part on a second maximum number of HARQ-ACK bundling groups. The method further comprising: dividing a first subset of the set of PDSCH transmissions into a first number of PDSCH sub-groups based at least in part on the first maximum number of HARQ-ACK bundling groups; and dividing a second subset of the set of PDSCH transmissions into a second number of PDSCH sub-groups based at least in part on the second maximum number of HARQ-ACK bundling groups. The method further comprising: generating an acknowledgement (ACK) as a HARQ-ACK information bit of a PDSCH sub-group if all of the PDSCH transmissions of the PDSCH sub-group are received correctly; or generating a negative acknowledgment (NACK) as the HARQ-ACK information bit of the PDSCH sub-group if not all of the PDSCH transmissions of the PDSCH sub-group are received correctly. The method further comprising: generating a first set of HARQ-ACK corresponding to a first subset of the set of PDSCH transmissions based at least in part on a first priority indication in the DCI; and generating a second set of HARQ-ACK corresponding to a second subset of the set of PDSCH transmissions based at least in part on a second priority indication different than the first priority indication. The second priority indication is a pre-determined value equivalent to the first priority indication indicated in the DCI; or the first priority indication has a high priority index of one, and the second priority indication has a low priority index of zero. The method further comprising: generating a first set of HARQ-ACK corresponding to a first subset of the set of PDSCH transmissions based at least in part on a first parameter; and generating a second set of HARQ-ACK corresponding to a second subset of the set of PDSCH transmissions based at least in part on a second parameter different than the first parameter, the first parameter and the second parameter indicated by higher layer signaling. The table row of the TDRA table comprises two sub-rows, and each of the sub-rows indicates time-domain resource allocation for a subset of the set of PDSCH transmissions. The method further comprising determining indices of the two sub-rows based on an index of the table row of the TDRA table and a configured number of the sub-rows associated with the TDRA table.

In a further example, the scheduling manager 304 may support wireless communication and/or network signaling at a device (e.g., the device 302, a UE) in accordance with examples as disclosed herein. The scheduling manager 304 and/or other device components may be configured as or otherwise support an apparatus, such as a UE, including a transceiver; a processor coupled to the transceiver, the processor and the transceiver configured to cause the apparatus to: receive control signaling comprising downlink control information (DCI) scheduling a set of physical uplink shared channel (PUSCH) transmissions, the DCI comprising an indication of a table row of a time domain resource allocation (TDRA) table, and the table row corresponding to multiple subsets of the set of PUSCH transmissions; generate a first subset of the set of the PUSCH transmissions based at least in part on a first priority; and generate a second subset of the set of the PUSCH transmissions based at least in part on a second priority different than the first priority.

Additionally, the apparatus (e.g., a UE) includes any one or combination of: the first subset and the second subset of the set of PUSCH transmissions are non-overlapping sets of PUSCH transmissions. The second priority indication is a pre-determined value equivalent to the first priority indication indicated in the DCI; or the first priority indication has a high priority index of one, and the second priority indication has a low priority index of zero. The processor and the transceiver are configured to cause the apparatus to: generate the first subset of the set of PUSCH transmissions based at least in part on a first parameter; and generate the second subset of the set of PUSCH transmissions based at least in part on a second parameter different than the first parameter, the first parameter and the second parameter indicated by higher layer signaling. The table row of the TDRA table comprises two sub-rows, and each of the sub-rows indicates time-domain resource allocation for a subset of the set of PUSCH transmissions. The processor and the transceiver are configured to cause the apparatus to determine indices of the two sub-rows based on an index of the table row of the TDRA table and a configured number of the sub-rows associated with the TDRA table.

The scheduling manager 304 and/or other device components may be configured as or otherwise support a means for wireless communication and/or network signaling at a UE, including receiving control signaling comprising downlink control information (DCI) scheduling a set of physical uplink shared channel (PUSCH) transmissions, the DCI comprising an indication of a table row of a time domain resource allocation (TDRA) table, and the table row corresponding to multiple subsets of the set of PUSCH transmissions; generating a first subset of the set of the PUSCH transmissions based at least in part on a first priority; and generating a second subset of the set of the PUSCH transmissions based at least in part on a second priority different than the first priority.

Additionally, wireless communication and/or network signaling at the UE includes any one or combination of: the first subset and the second subset of the set of PUSCH transmissions are non-overlapping sets of PUSCH transmissions. The second priority indication is a pre-determined value equivalent to the first priority indication indicated in the DCI; or the first priority indication has a high priority index of one, and the second priority indication has a low priority index of zero. The method further comprising: generating the first subset of the set of PUSCH transmissions based at least in part on a first parameter; and generating the second subset of the set of PUSCH transmissions based at least in part on a second parameter different than the first parameter, the first parameter and the second parameter indicated by higher layer signaling. The table row of the TDRA table comprises two sub-rows, and each of the sub-rows indicates time-domain resource allocation for a subset of the set of PUSCH transmissions. The method further comprising determining indices of the two sub-rows based on an index of the table row of the TDRA table and a configured number of the sub-rows associated with the TDRA table.

The processor 306 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 306 may be configured to operate a memory array using a memory controller. In some other implementations, a memory controller may be integrated into the processor 306. The processor 306 may be configured to execute computer-readable instructions stored in a memory (e.g., the memory 308) to cause the device 302 to perform various functions of the present disclosure.

The memory 308 may include random access memory (RAM) and read-only memory (ROM). The memory 308 may store computer-readable, computer-executable code including instructions that, when executed by the processor 306 cause the device 302 to perform various functions described herein. The code may be stored in a non-transitory computer-readable medium such as system memory or another type of memory. In some implementations, the code may not be directly executable by the processor 306 but may cause a computer (e.g., when compiled and executed) to perform functions described herein. In some implementations, the memory 308 may include, among other things, a basic I/O system (BIOS) which may control basic hardware or software operation such as the interaction with peripheral components or devices.

The I/O controller 314 may manage input and output signals for the device 302. The I/O controller 314 may also manage peripherals not integrated into the device 302. In some implementations, the I/O controller 314 may represent a physical connection or port to an external peripheral. In some implementations, the I/O controller 314 may utilize an operating system such as iOS®, ANDROID®, MS-DOS®, MS-WINDOWS®, OS/2®, UNIX®, LINUX®, or another known operating system. In some implementations, the I/O controller 314 may be implemented as part of a processor, such as the processor 306. In some implementations, a user may interact with the device 302 via the I/O controller 314 or via hardware components controlled by the I/O controller 314.

In some implementations, the device 302 may include a single antenna 316. However, in some other implementations, the device 302 may have more than one antenna 316, which may be capable of concurrently transmitting or receiving multiple wireless transmissions. The receiver 310 and the transmitter 312 may communicate bi-directionally, via the one or more antennas 316, wired, or wireless links as described herein. For example, the receiver 310 and the transmitter 312 may represent a wireless transceiver and may communicate bi-directionally with another wireless transceiver. The transceiver may also include a modem to modulate the packets, to provide the modulated packets to one or more antennas 316 for transmission, and to demodulate packets received from the one or more antennas 316.

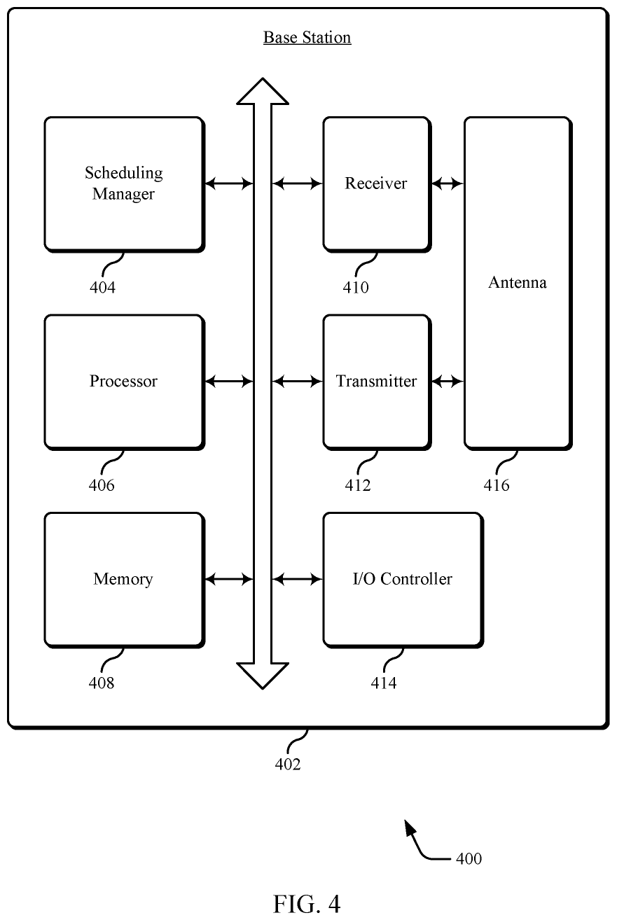

FIG. 4 illustrates an example of a block diagram 400 of a device 402 that supports multi-channel scheduling in accordance with aspects of the present disclosure. The device 402 may be an example of a base station 102, such as a gNB as described herein. The device 402 may support wireless communication and/or network signaling with one or more base stations 102, other UEs 104, core network devices and functions (e.g., core network 106), or any combination thereof. The device 402 may include components for bi-directional communications including components for transmitting and receiving communications, such as a scheduling manager 404, a processor 406, a memory 408, a receiver 410, a transmitter 412, and an I/O controller 414. These components may be in electronic communication or otherwise coupled (e.g., operatively, communicatively, functionally, electronically, electrically) via one or more interfaces (e.g., buses).

The scheduling manager 404, the receiver 410, the transmitter 412, or various combinations thereof or various components thereof may be examples of means for performing various aspects of the present disclosure as described herein. For example, the scheduling manager 404, the receiver 410, the transmitter 412, or various combinations or components thereof may support a method for performing one or more of the functions described herein.

In some implementations, the scheduling manager 404, the receiver 410, the transmitter 412, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 406 and the memory 408 coupled with the processor 406 may be configured to perform one or more of the functions described herein (e.g., by executing, by the processor 406, instructions stored in the memory 408).

Additionally or alternatively, in some implementations, the scheduling manager 404, the receiver 410, the transmitter 412, or various combinations or components thereof may be implemented in code (e.g., as communications management software or firmware) executed by the processor 406. If implemented in code executed by the processor 406, the functions of the scheduling manager 404, the receiver 410, the transmitter 412, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduling manager 404 may be configured to perform various operations (e.g., receiving, monitoring, transmitting) using or otherwise in cooperation with the receiver 410, the transmitter 412, or both. For example, the scheduling manager 404 may receive information from the receiver 410, send information to the transmitter 412, or be integrated in combination with the receiver 410, the transmitter 412, or both to receive information, transmit information, or perform various other operations as described herein. Although the scheduling manager 404 is illustrated as a separate component, in some implementations, one or more functions described with reference to the scheduling manager 404 may be supported by or performed by the processor 406, the memory 408, or any combination thereof. For example, the memory 408 may store code, which may include instructions executable by the processor 406 to cause the device 402 to perform various aspects of the present disclosure as described herein, or the processor 406 and the memory 408 may be otherwise configured to perform or support such operations.

For example, the scheduling manager 404 may support wireless communication and/or network signaling at a device (e.g., the device 402, a base station) in accordance with examples as disclosed herein. The scheduling manager 404 and/or other device components may be configured as or otherwise support an apparatus, such as a base station, including a transceiver; a processor coupled to the transceiver, the processor and the transceiver configured to cause the apparatus to: transmit control signaling comprising downlink control information (DCI) to schedule a set of physical downlink shared channel (PDSCH) transmissions for a user equipment (UE), the DCI comprising an indication of a table row of a time domain resource allocation (TDRA) table, and the table row corresponding to multiple subsets of the set of PDSCH transmissions; transmit the set of PDSCH transmissions to the UE; and receive a respective hybrid automatic repeat request acknowledgement (HARQ-ACK) corresponding to respective one or more of the multiple subsets of the set of PDSCH transmissions.

Additionally, the apparatus (e.g., a base station) includes any one or combination of: the processor and the transceiver are configured to cause the apparatus to: receive a first set of HARQ-ACK corresponding to a first subset of the set of PDSCH transmissions; and receive a second set of HARQ-ACK corresponding to a second subset of the set of PDSCH transmissions. The first set of HARQ-ACK is based at least in part on a first priority, and the second set of HARQ-ACK is based at least in part on a second priority different than the first priority. The first set of HARQ-ACK is based at least in part on a first bundling group indication, and the second set of HARQ-ACK is based at least in part on a second bundling group indication. The first set of HARQ-ACK is based at least in part on a first maximum number of HARQ-ACK bundling groups, and the second set of HARQ-ACK is based at least in part on a second maximum number of HARQ-ACK bundling groups.

The scheduling manager 404 and/or other device components may be configured as or otherwise support a means for wireless communication and/or network signaling at a base station, including transmitting control signaling comprising downlink control information (DCI) to schedule a set of physical downlink shared channel (PDSCH) transmissions for a user equipment (UE), the DCI comprising an indication of a table row of a time domain resource allocation (TDRA) table, and the table row corresponding to multiple subsets of the set of PDSCH transmissions; transmitting the set of PDSCH transmissions to the UE; and receiving a respective hybrid automatic repeat request acknowledgement (HARQ-ACK) corresponding to respective one or more of the multiple subsets of the set of PDSCH transmissions.

Additionally, wireless communication at the base station includes any one or combination of: receiving a first set of HARQ-ACK corresponding to a first subset of the set of PDSCH transmissions; and receiving a second set of HARQ-ACK corresponding to a second subset of the set of PDSCH transmissions. The first set of HARQ-ACK is based at least in part on a first priority, and the second set of HARQ-ACK is based at least in part on a second priority different than the first priority. The first set of HARQ-ACK is based at least in part on a first bundling group indication, and the second set of HARQ-ACK is based at least in part on a second bundling group indication. The first set of HARQ-ACK is based at least in part on a first maximum number of HARQ-ACK bundling groups, and the second set of HARQ-ACK is based at least in part on a second maximum number of HARQ-ACK bundling groups.

The processor 406 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 406 may be configured to operate a memory array using a memory controller. In some other implementations, a memory controller may be integrated into the processor 406. The processor 406 may be configured to execute computer-readable instructions stored in a memory (e.g., the memory 408) to cause the device 402 to perform various functions of the present disclosure.

The memory 408 may include random access memory (RAM) and read-only memory (ROM). The memory 408 may store computer-readable, computer-executable code including instructions that, when executed by the processor 406 cause the device 402 to perform various functions described herein. The code may be stored in a non-transitory computer-readable medium such as system memory or another type of memory. In some implementations, the code may not be directly executable by the processor 406 but may cause a computer (e.g., when compiled and executed) to perform functions described herein. In some implementations, the memory 408 may include, among other things, a basic I/O system (BIOS) which may control basic hardware or software operation such as the interaction with peripheral components or devices.

The I/O controller 414 may manage input and output signals for the device 402. The I/O controller 414 may also manage peripherals not integrated into the device 402. In some implementations, the I/O controller 414 may represent a physical connection or port to an external peripheral. In some implementations, the I/O controller 414 may utilize an operating system such as iOS®, ANDROID®, MS-DOS®, MS-WINDOWS®, OS/2®, UNIX®, LINUX®, or another known operating system. In some implementations, the I/O controller 414 may be implemented as part of a processor, such as the processor 406. In some implementations, a user may interact with the device 402 via the I/O controller 414 or via hardware components controlled by the I/O controller 414.

In some implementations, the device 402 may include a single antenna 416. However, in some other implementations, the device 402 may have more than one antenna 416, which may be capable of concurrently transmitting or receiving multiple wireless transmissions. The receiver 410 and the transmitter 412 may communicate bi-directionally, via the one or more antennas 416, wired, or wireless links as described herein. For example, the receiver 410 and the transmitter 412 may represent a wireless transceiver and may communicate bi-directionally with another wireless transceiver. The transceiver may also include a modem to modulate the packets, to provide the modulated packets to one or more antennas 416 for transmission, and to demodulate packets received from the one or more antennas 416.

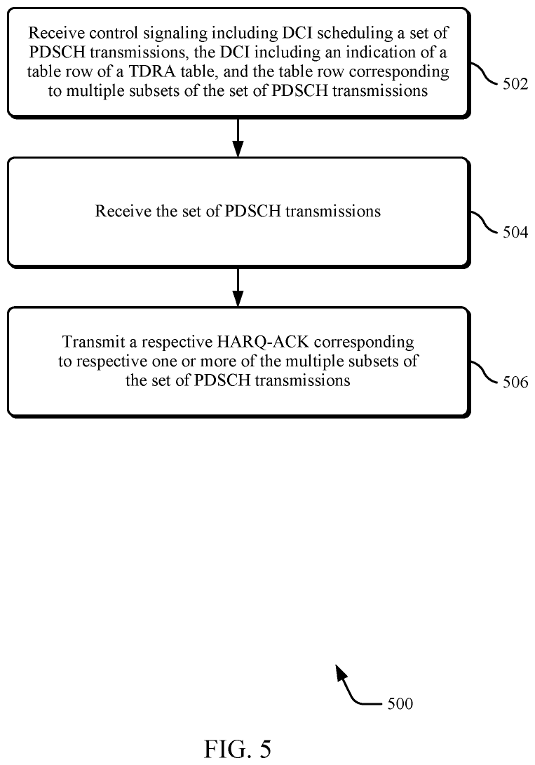

FIG. 5 illustrates a flowchart of a method 500 that supports multi-channel scheduling in accordance with aspects of the present disclosure. The operations of the method 500 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 502, the method may include receiving control signaling including DCI scheduling a set of PDSCH transmissions, the DCI including an indication of a table row of a TDRA table, and the table row corresponding to multiple subsets of the set of PDSCH transmissions. The operations of 502 may be performed in accordance with examples as described herein. In some implementations, aspects of the operations of 502 may be performed by a device as described with reference to FIG. 1.

At 504, the method may include receiving the set of PDSCH transmissions. The operations of 504 may be performed in accordance with examples as described herein. In some implementations, aspects of the operations of 504 may be performed by a device as described with reference to FIG. 1.

At 506, the method may include transmitting a respective HARQ-ACK corresponding to respective one or more of the multiple subsets of the set of PDSCH transmissions. The operations of 506 may be performed in accordance with examples as described herein. In some implementations, aspects of the operations of 506 may be performed by a device as described with reference to FIG. 1.

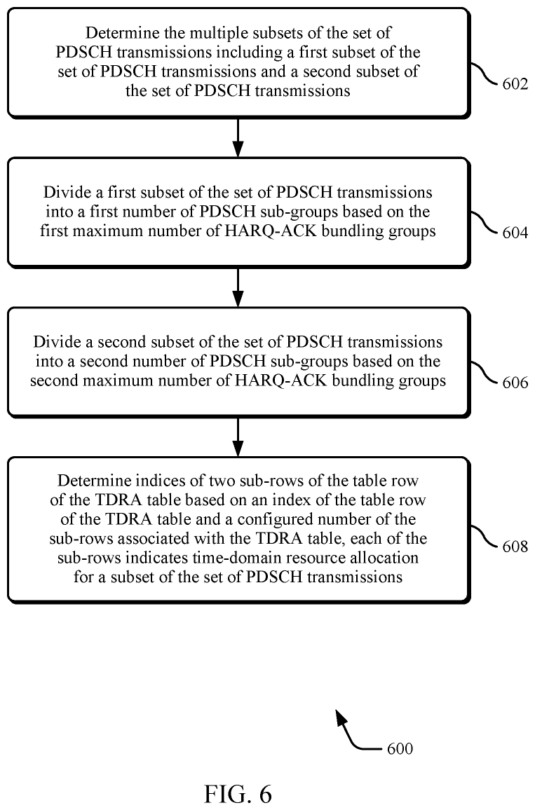

FIG. 6 illustrates a flowchart of a method 600 that supports multi-channel scheduling in accordance with aspects of the present disclosure. The operations of the method 600 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 602, the method may include determining the multiple subsets of the set of PDSCH transmissions including a first subset of the set of PDSCH transmissions and a second subset of the set of PDSCH transmissions. In implementations, the first subset and the second subset of the set of PDSCH transmissions are non-overlapping sets of PDSCH transmissions. The operations of 602 may be performed in accordance with examples as described herein. In some implementations, aspects of the operations of 602 may be performed by a device as described with reference to FIG. 1.

At 604, the method may include dividing a first subset of the set of PDSCH transmissions into a first number of PDSCH sub-groups based on the first maximum number of HARQ-ACK bundling groups. The operations of 604 may be performed in accordance with examples as described herein. In some implementations, aspects of the operations of 604 may be performed by a device as described with reference to FIG. 1.

At 606, the method may include dividing a second subset of the set of PDSCH transmissions into a second number of PDSCH sub-groups based on the second maximum number of HARQ-ACK bundling groups. The operations of 606 may be performed in accordance with examples as described herein. In some implementations, aspects of the operations of 606 may be performed by a device as described with reference to FIG. 1.

At 608, the method may include determining indices of two sub-rows of the table row of the TDRA table based on an index of the table row of the TDRA table and a configured number of the sub-rows associated with the TDRA table, each of the sub-rows indicates time-domain resource allocation for a subset of the set of PDSCH transmissions. The operations of 608 may be performed in accordance with examples as described herein. In some implementations, aspects of the operations of 608 may be performed by a device as described with reference to FIG. 1.

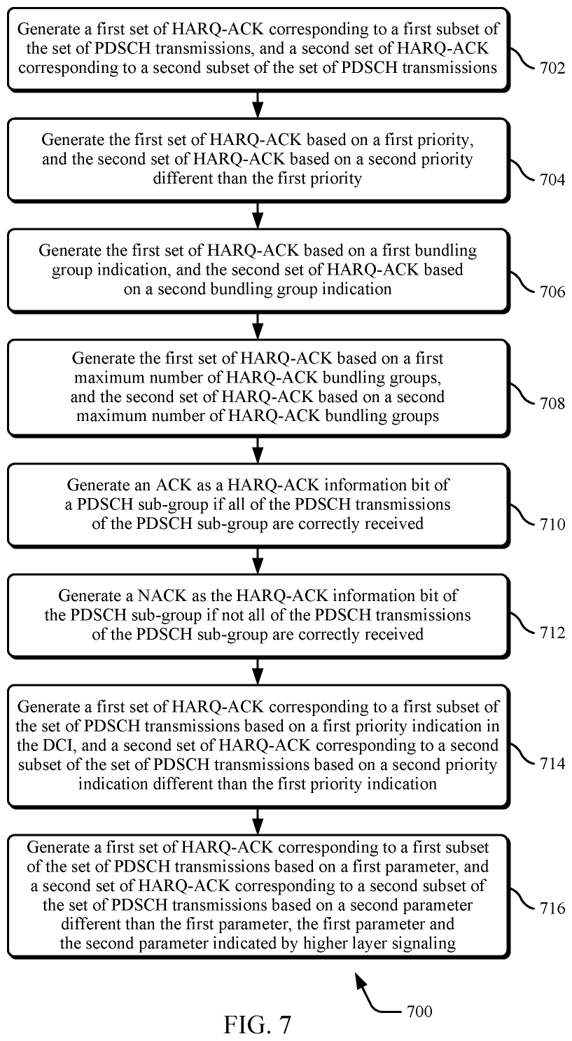

FIG. 7 illustrates a flowchart of a method 700 that supports multi-channel scheduling in accordance with aspects of the present disclosure. The operations of the method 700 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 702, the method may include generating a first set of HARQ-ACK corresponding to a first subset of the set of PDSCH transmissions, and a second set of HARQ-ACK corresponding to a second subset of the set of PDSCH transmissions. The operations of 702 may be performed in accordance with examples as described herein. In some implementations, aspects of the operations of 702 may be performed by a device as described with reference to FIG. 1.

At 704, the method may include generating the first set of HARQ-ACK based on a first priority, and the second set of HARQ-ACK based on a second priority different than the first priority. The operations of 704 may be performed in accordance with examples as described herein. In some implementations, aspects of the operations of 704 may be performed by a device as described with reference to FIG. 1.

At 706, the method may include generating the first set of HARQ-ACK based on a first bundling group indication, and the second set of HARQ-ACK based on a second bundling group indication. The operations of 706 may be performed in accordance with examples as described herein. In some implementations, aspects of the operations of 706 may be performed by a device as described with reference to FIG. 1.

At 708, the method may include generating the first set of HARQ-ACK based on a first maximum number of HARQ-ACK bundling groups, and the second set of HARQ-ACK based on a second maximum number of HARQ-ACK bundling groups. The operations of 708 may be performed in accordance with examples as described herein. In some implementations, aspects of the operations of 708 may be performed by a device as described with reference to FIG. 1.

At 710, the method may include generating an ACK as a HARQ-ACK information bit of a PDSCH sub-group if all of the PDSCH transmissions of the PDSCH sub-group are correctly received. The operations of 710 may be performed in accordance with examples as described herein. In some implementations, aspects of the operations of 710 may be performed by a device as described with reference to FIG. 1.

At 712, the method may include generating a NACK as the HARQ-ACK information bit of the PDSCH sub-group if not all of the PDSCH transmissions of the PDSCH sub-group are correctly received. The operations of 712 may be performed in accordance with examples as described herein. In some implementations, aspects of the operations of 712 may be performed by a device as described with reference to FIG. 1.

At 714, the method may include generating a first set of HARQ-ACK corresponding to a first subset of the set of PDSCH transmissions based on a first priority indication in the DCI, and a second set of HARQ-ACK corresponding to a second subset of the set of PDSCH transmissions based on a second priority indication different than the first priority indication. The operations of 714 may be performed in accordance with examples as described herein. In some implementations, aspects of the operations of 714 may be performed by a device as described with reference to FIG. 1.

At 716, the method may include generating a first set of HARQ-ACK corresponding to a first subset of the set of PDSCH transmissions based on a first parameter, and a second set of HARQ-ACK corresponding to a second subset of the set of PDSCH transmissions based on a second parameter different than the first parameter, the first parameter and the second parameter indicated by higher layer signaling. The operations of 716 may be performed in accordance with examples as described herein. In some implementations, aspects of the operations of 716 may be performed by a device as described with reference to FIG. 1.

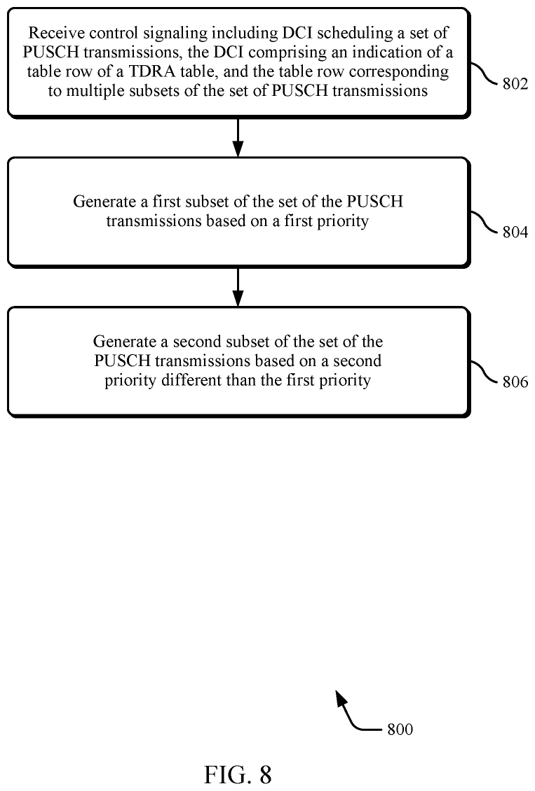

FIG. 8 illustrates a flowchart of a method 800 that supports multi-channel scheduling in accordance with aspects of the present disclosure. The operations of the method 800 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 802, the method may include receiving control signaling including DCI scheduling a set of PUSCH transmissions, the DCI comprising an indication of a table row of a TDRA table, and the table row corresponding to multiple subsets of the set of PUSCH transmissions. In implementations, a first subset and a second subset of the set of PUSCH transmissions are non-overlapping sets of PUSCH transmissions. The operations of 802 may be performed in accordance with examples as described herein. In some implementations, aspects of the operations of 802 may be performed by a device as described with reference to FIG. 1.

At 804, the method may include generating a first subset of the set of the PUSCH transmissions based on a first priority. The operations of 804 may be performed in accordance with examples as described herein. In some implementations, aspects of the operations of 804 may be performed by a device as described with reference to FIG. 1.

At 806, the method may include generating a second subset of the set of the PUSCH transmissions based on a second priority different than the first priority. The operations of 806 may be performed in accordance with examples as described herein. In some implementations, aspects of the operations of 806 may be performed by a device as described with reference to FIG. 1.

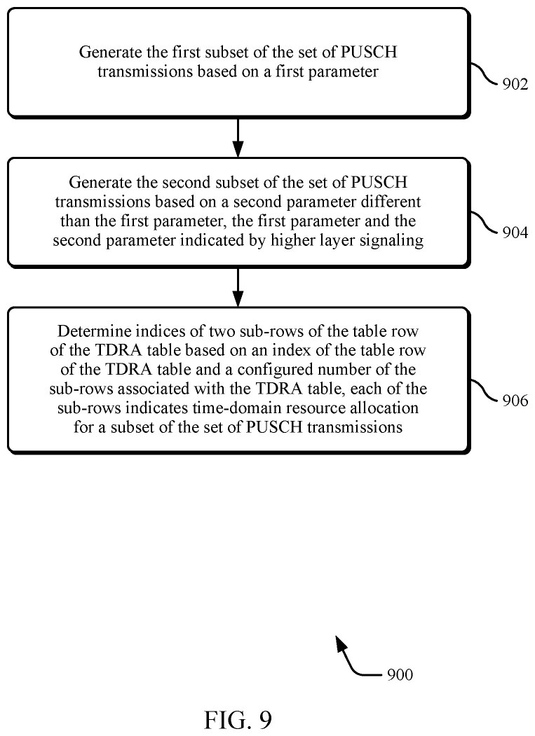

FIG. 9 illustrates a flowchart of a method 900 that supports multi-channel scheduling in accordance with aspects of the present disclosure. The operations of the method 900 may be implemented and performed by a device or its components, such as a UE 104 as described with reference to FIGS. 1 through 4. In some implementations, the device may execute a set of instructions to control the function elements of the device to perform the described functions. Additionally, or alternatively, the device may perform aspects of the described functions using special-purpose hardware.

At 902, the method may include generating the first subset of the set of PUSCH transmissions based on a first parameter. The operations of 902 may be performed in accordance with examples as described herein. In some implementations, aspects of the operations of 902 may be performed by a device as described with reference to FIG. 1.

At 904, the method may include generating the second subset of the set of PUSCH transmissions based on a second parameter different than the first parameter, the first parameter and the second parameter indicated by higher layer signaling. The operations of 904 may be performed in accordance with examples as described herein. In some implementations, aspects of the operations of 904 may be performed by a device as described with reference to FIG. 1.

At 906, the method may include determining indices of two sub-rows of the table row of the TDRA table based on an index of the table row of the TDRA table and a configured number of the sub-rows associated with the TDRA table, each of the sub-rows indicates time-domain resource allocation for a subset of the set of PUSCH transmissions. The operations of 906 may be performed in accordance with examples as described herein. In some implementations, aspects of the operations of 906 may be performed by a device as described with reference to FIG. 1.

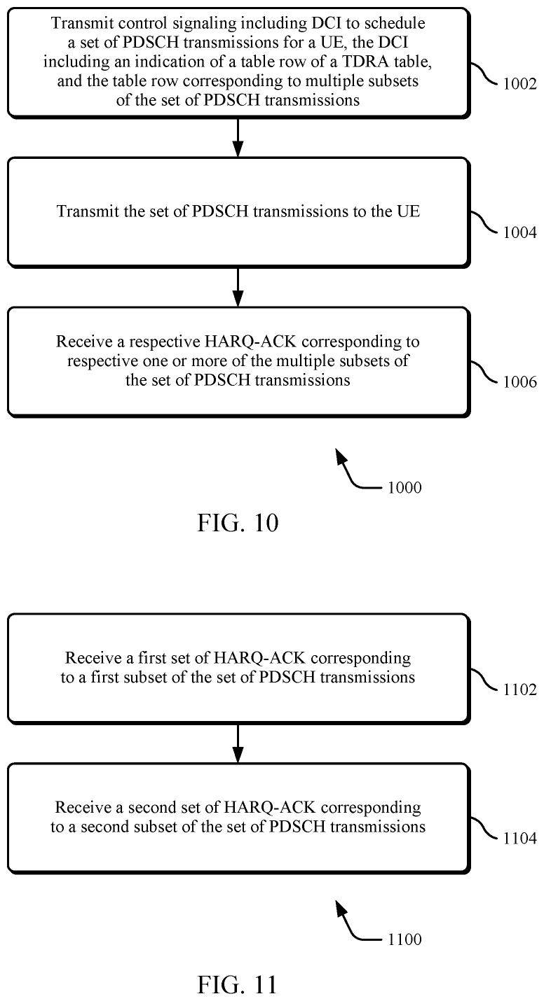

FIG. 10 illustrates a flowchart of a method 1000 that supports multi-channel scheduling in accordance with aspects of the present disclosure. The operations of the method 1000 may be implemented and performed by a device or its components, such as a base station 102 (e.g., gNB) as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1002, the method may include transmitting control signaling including DCI to schedule a set of PDSCH transmissions for a UE, the DCI including an indication of a table row of a TDRA table, and the table row corresponding to multiple subsets of the set of PDSCH transmissions. The operations of 1002 may be performed in accordance with examples as described herein. In some implementations, aspects of the operations of 1002 may be performed by a device as described with reference to FIG. 1.

At 1004, the method may include transmitting the set of PDSCH transmissions to the UE. The operations of 1004 may be performed in accordance with examples as described herein. In some implementations, aspects of the operations of 1004 may be performed by a device as described with reference to FIG. 1.

At 1006, the method may include receiving a respective HARQ-ACK corresponding to respective one or more of the multiple subsets of the set of PDSCH transmissions. The operations of 1006 may be performed in accordance with examples as described herein. In some implementations, aspects of the operations of 1006 may be performed by a device as described with reference to FIG. 1.

FIG. 11 illustrates a flowchart of a method 1100 that supports multi-channel scheduling in accordance with aspects of the present disclosure. The operations of the method 1100 may be implemented and performed by a device or its components, such as a base station 102 (e.g., gNB) as described with reference to FIGS. 1 through 4. In some implementations, the device may execute a set of instructions to control the function elements of the device to perform the described functions. Additionally, or alternatively, the device may perform aspects of the described functions using special-purpose hardware.

At 1102, the method may include receiving a first set of HARQ-ACK corresponding to a first subset of the set of PDSCH transmissions. The operations of 1102 may be performed in accordance with examples as described herein. In some implementations, aspects of the operations of 1102 may be performed by a device as described with reference to FIG. 1.

At 1104, the method may include receiving a second set of HARQ-ACK corresponding to a second subset of the set of PDSCH transmissions. The operations of 1104 may be performed in accordance with examples as described herein. In some implementations, aspects of the operations of 1104 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive control signaling comprising downlink control information (DCI) scheduling a set of physical downlink shared channel (PDSCH) transmissions, the DCI comprising an indication of a table row of a time domain resource allocation (TDRA) table, and the table row corresponding to multiple subsets of the set of PDSCH transmissions;
receive the set of PDSCH transmissions; and
transmit a respective hybrid automatic repeat request acknowledgement (HARQ-ACK) corresponding to respective one or more of the multiple subsets of the set of PDSCH transmissions.

2. The UE of claim 1, wherein the at least one processor is configured to cause the UE to determine the multiple subsets of the set of PDSCH transmissions comprising a first subset of the set of PDSCH transmissions and a second subset of the set of PDSCH transmissions.

3. The UE of claim 2, wherein the first subset and the second subset of the set of PDSCH transmissions are non-overlapping sets of PDSCH transmissions.

4. The UE of claim 3, wherein the DCI comprises an indication as to whether the first subset of the PDSCH transmissions occurs prior to the second subset of the PDSCH transmissions.

5. The UE of claim 1, wherein the at least one processor is configured to cause the UE to:
generate a first set of HARQ-ACK corresponding to a first subset of the set of PDSCH transmissions; and
generate a second set of HARQ-ACK corresponding to a second subset of the set of PDSCH transmissions.

6. The UE of claim 5, wherein the at least one processor is configured to cause the UE to:
generate the first set of HARQ-ACK based at least in part on a first priority; and
generate the second set of HARQ-ACK based at least in part on a second priority different than the first priority.

7. The UE of claim 5, wherein the at least one processor is configured to cause the UE to:
generate the first set of HARQ-ACK based at least in part on a first bundling group indication; and
generate the second set of HARQ-ACK based at least in part on a second bundling group indication.

8. The UE of claim 1, wherein the at least one processor is configured to cause the UE to:
generate a first set of HARQ-ACK corresponding to a first subset of the set of PDSCH transmissions based at least in part on a first priority indication in the DCI; and
generate a second set of HARQ-ACK corresponding to a second subset of the set of PDSCH transmissions based at least in part on a second priority indication different than the first priority indication.

9. The UE of claim 8, wherein at least one of:
the second priority indication is a pre-determined value equivalent to the first priority indication indicated in the DCI; or
the first priority indication has a high priority index of one, and the second priority indication has a low priority index of zero.

10. The UE of claim 1, wherein the at least one processor is configured to cause the UE to:
generate a first set of HARQ-ACK corresponding to a first subset of the set of PDSCH transmissions based at least in part on a first parameter; and
generate a second set of HARQ-ACK corresponding to a second subset of the set of PDSCH transmissions based at least in part on a second parameter different than the first parameter, the first parameter and the second parameter indicated by higher layer signaling.

11. The UE of claim 1, wherein the table row of the TDRA table comprises two sub-rows, and each of the sub-rows indicates time-domain resource allocation for a subset of the set of PDSCH transmissions.

12. The UE of claim 11, wherein the at least one processor is configured to cause the UE to determine indices of the two sub-rows based on an index of the table row of the TDRA table and a configured number of the sub-rows associated with the TDRA table.

13. A base station (BS) for wireless communication, comprising:
at least one memory; and
at least one processor coupled with the at least one memory and configured to cause the BS to:
transmit control signaling comprising downlink control information (DCI) to schedule a set of physical downlink shared channel (PDSCH) transmissions for a user equipment (UE), the DCI comprising an indication of a table row of a time domain resource allocation (TDRA) table, and the table row corresponding to multiple subsets of the set of PDSCH transmissions;
transmit the set of PDSCH transmissions to the UE; and
receive a respective hybrid automatic repeat request acknowledgement (HARQ-ACK) corresponding to respective one or more of the multiple subsets of the set of PDSCH transmissions.

14, 15. (canceled)

16. An A user equipment (UE) for wireless communication, comprising:
at least one memory; and
at least one processor coupled with the at least one memory and configured to cause the UE to:
receive control signaling comprising downlink control information (DCI) scheduling a set of physical uplink shared channel (PUSCH) transmissions, the DCI comprising an indication of a table row of a time domain resource allocation (TDRA) table, and the table row corresponding to multiple subsets of the set of PUSCH transmissions;
generate a first subset of the set of the PUSCH transmissions based at least in part on a first priority; and
generate a second subset of the set of the PUSCH transmissions based at least in part on a second priority different than the first priority.

17. The UE of claim 16, wherein the first subset and the second subset of the set of PUSCH transmissions are non-overlapping sets of PUSCH transmissions.

18. The UE of claim 16, wherein at least one of:
the second priority indication is a pre-determined value equivalent to the first priority indication indicated in the DCI; or
the first priority indication has a high priority index of one, and the second priority indication has a low priority index of zero.

19. The UE of claim 16, wherein the at least one processor is configured to cause the UE to:
generate the first subset of the set of PUSCH transmissions based at least in part on a first parameter; and
generate the second subset of the set of PUSCH transmissions based at least in part on a second parameter different than the first parameter, the first parameter and the second parameter indicated by higher layer signaling.

20. The UE of claim 16, wherein:
the table row of the TDRA table comprises two sub-rows, and each of the sub-rows indicates time-domain resource allocation for a subset of the set of PUSCH transmissions; and
the at least one processor is configured to cause the UE to determine indices of the two sub-rows based on an index of the table row of the TDRA table and a configured number of the sub-rows associated with the TDRA table.

21. A processor for wireless communication, comprising:
at least one controller coupled with at least one memory and configured to cause the processor to:
receive control signaling comprising downlink control information (DCI) scheduling a set of physical downlink shared channel (PDSCH) transmissions, the DCI comprising an indication of a table row of a time domain resource allocation (TDRA) table, and the table row corresponding to multiple subsets of the set of PDSCH transmissions;
receive the set of PDSCH transmissions; and
transmit a respective hybrid automatic repeat request acknowledgement (HARQ-ACK) corresponding to respective one or more of the multiple subsets of the set of PDSCH transmissions.

22. The processor of claim 21, wherein the at least one controller is configured to cause the processor to determine the multiple subsets of the set of PDSCH transmissions comprising a first subset of the set of PDSCH transmissions and a second subset of the set of PDSCH transmissions.
